(19) United States
(12) Patent Application Publication
(10) Pub. No.: US 2002/0101737 A1
(43) Pub. Date: Aug. 1, 2002

(54) Adapting seat for a light

(75) Inventor: Ying-Cou Wang, Taipei (TW)

Correspondence Address: OSTROLENK FABER GERB & SOFFEN, 1180 AVENUE OF THE AMERICAS, NEW YORK, NY, 100368403

(73) Assignee: EMCOM Technology Inc.

(21) Appl. No.: 09/771,183

(22) Filed: Jan. 26, 2001

(51) Int. Cl. F21V 21/00

(52) U.S. Cl. 362/368; 362/370; 362/371

(57) ABSTRACT

An adapting seat includes a first frame with a first pair of notches respectively defined in opposed inner walls of the first frame The second frame is able to be matingly inserted into the first frame and has a second pair of notches respectively defined in outer walls of the second frame and a third pair of notches respectively defined in outer walls of the second frame. The axis between the second pair of notches is orthogonal to the axis between the first pair of notches and the axis between the second pair of notches is orthogonal to the axis between the third pair of notches, such that the second pair of notches and the third pair of notches of the second frame enable the adapting seat to be mounted on a hole orientated in either the horizontal or vertical direction relative to the ground.

### BACKGROUND OF THE INVENTION

1. Field of the Invention

The present invention relates to an adapting seat for a light, and more particularly to an adapting seat having a pair of openings defined in opposite side walls of a first frame and a second frame such that the positioning seat is able to be mounted on a rectangular hole with a longer side orientated either in horizontal or vertical direction relative to the ground.

2. Description of Related Art

Conventionally, when a house is newly built, rectangular holes are defined in walls for mounting lights. It is noted from FIG. 3 that a conventional light set has an adapter (50) with a space (51), a pair of notches (52) defined in opposed inner walls defining the space (51) and a light assembly (53) securely engaged with the adapter (50). Therefore, a pair of bolts (not shown) is able to be inserted into the notches (52) to firmly position the light set in an opening predetermined in a wall and having the same orientation as that of the adapter (50).

However, when the light set has a predetermined orientation, that is, changing the orientation of the light set will literally reduce the utility or the entire function of the light set, the orientation of the rectangular hole becomes important. Unfortunately, in practice, a light set normally is the last thing to be mounted on the wall of a house. That is, the holes are already defined in the walls of a house long before the purchase of the light sets. Naturally, mismatch happens between the orientation of the light set and the orientation of the rectangular hole on the wall, which will leave an ugly appearance on the wall if the light set is still mounted on the wall regardless of the orientation difference. In order to solve the problem, some light sets are provided with rectangular holes respectively orientated in horizontal and vertical to the ground. This does solve the problem of mismatch, but it needs a horizontally orientated adapter (50) and a vertically oriented adapter (50) and it increases cost of the light sets.

In order to obviate and mitigate the foregoing problem, it is an objective of the invention to provide an improved adapting seat for a light.

### SUMMARY OF THE INVENTION

The primary objective of the invention is to provide an improved adapting seat having a first pair of notches defined in inner walls of a first frame and a second pair of notches defined in outer walls of a second frame that is inserted into the first frame. The second frame further has a third pair of notches. With the first and second pairs of notches, the light set is able to orient to a hole with either a horizontal or a vertical direction relative to the ground.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the adapting seat in accordance with the present invention;

FIG. 2 is an exploded perspective view of the adapting seat of the invention of another preferred embodiment; and

FIG. 3 is an exploded perspective view showing the conventional adapter of a light.

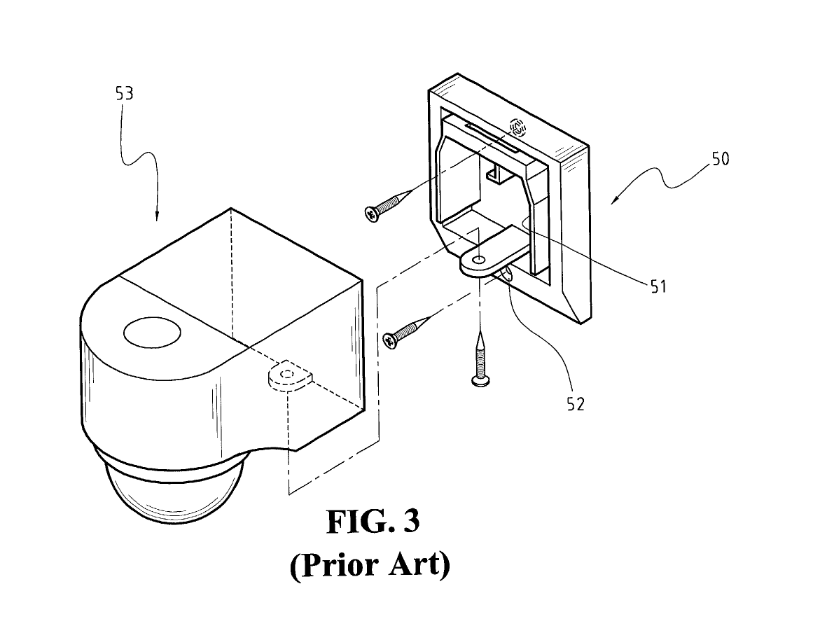

### DETAILED DESCRIPTION OF THE PREFERRED EMBODIMENT

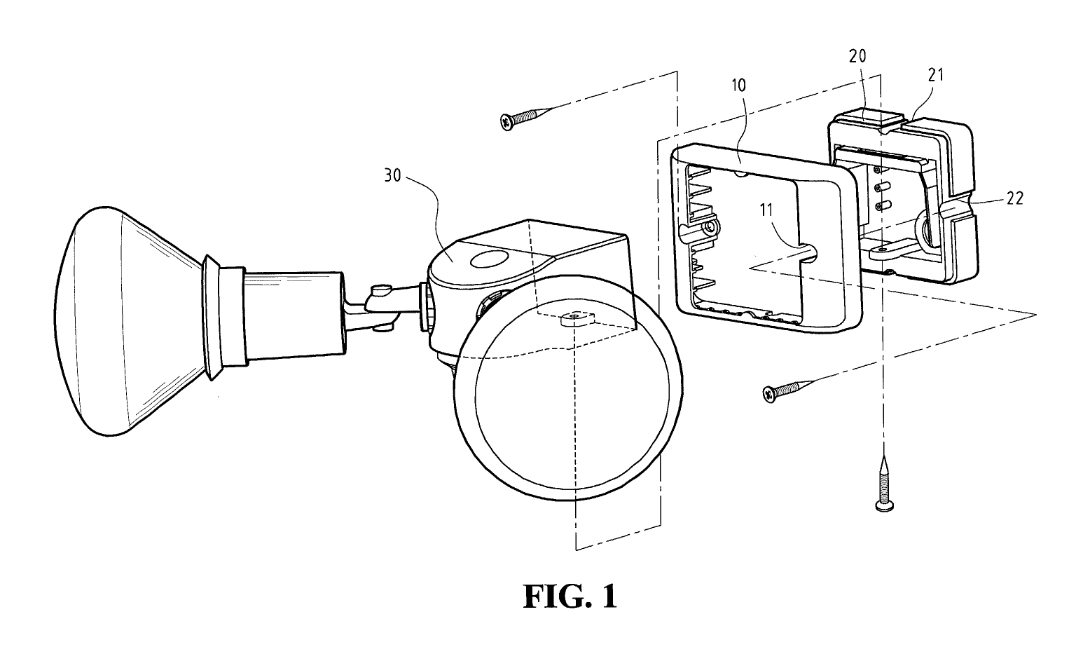

With reference to FIG. 1, the adapting seat in accordance with the present invention has a first frame (10), a second frame (20) and a light assembly (30).

The first frame (10) is hollow and has a first pair of notches (11) respectively defined in opposed inner walls of the first frame (10).

The second frame (20) is able to be matingly inserted into the hollow first frame (10) and has a second pair of notches (21) respectively defined in outer walls of the second frame (20) and a third pair of notches (22) respectively defined in outer walls of the second frame (20). The axis between the second pair of notches (21) is orthogonal to the axis between the first pair of notches (11) and the axis between the second pair of notches (21) is orthogonal to the axis between the third pair of notches (22), such that when the second frame (20) is matingly inserted into the hollow first frame (10), the second pair of notches (21) and the third pair of notches (22) of the second frame enable the adapting seat to be mounted on a hole orientated in either the horizontal or vertical direction relative to the ground.

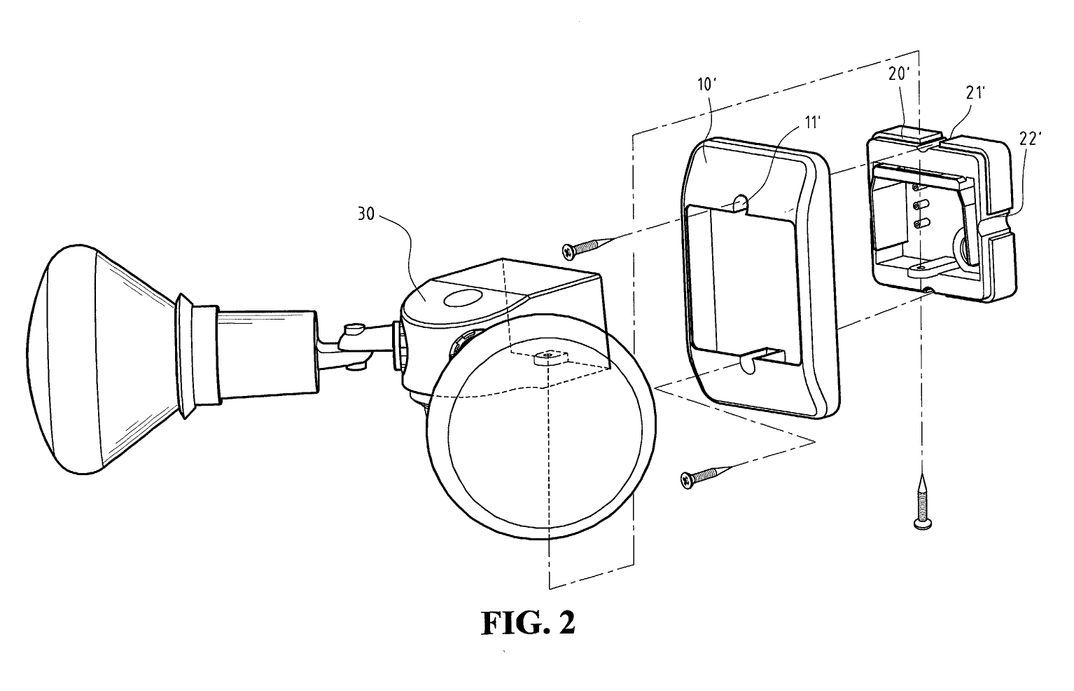

With reference to FIG. 2, another preferred embodiment of the invention is shown. The adapting seat in accordance with the present invention has a first frame (10′), a second frame (20′) and a light assembly (30).

The first frame (10′) is hollow and has a first pair of notches (11′) respectively defined in opposed inner walls of the first frame (10′).

The second frame (20′) is able to be matingly inserted into the hollow first frame (10′) and has a second pair of notches (21′) respectively defined in outer walls of the second frame (20′) and a third pair of notches (22′) respectively defined in outer walls of the second frame (20′). The axis between the second pair of notches (21′) is orthogonal to the axis between the first pair of notches (11′) and the axis between the second pair of notches (21′) is orthogonal to the axis between the third pair of notches (22′), such that when the second frame (20′) is matingly inserted into the hollow first frame (10′), the second pair of notches (21′) and the third pair of notches (22′) of the second frame enable the adapting seat to be mounted on a hole orientated in either the horizontal or vertical direction relative to the ground.

It is to be noted that if the hole in the wall is horizontally orientated with respect to the ground, as shown in FIG. 1, the first frame (10) is able to mate with the horizontally orientated hole and if the hole in the wall is vertically orientated with respect to the ground, as shown in FIG. 2, the first frame (10′) is able to be mate with the vertically orientated hole. In either cases, the second frame (20,20′) is fixed in one orientation and only the first frame (10,10′) orientated in accordance with the orientation of the hole in the wall, such that the light is able to always orient to one fixed direction despite the orientation of the hole.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adapting seat for a light comprising:
a hollow first frame having a first pair of notches respectively defined in opposed inner walls of the first frame;
a second frame matingly inserted into the hollow first frame and having a second pair of notches respectively defined in outer walls of the second frame and a third pair of notches respectively defined in outer walls of the second frame;
wherein the axis between the second pair of notches is orthogonal to the axis between the first pair of notches and the axis between the second pair of notches is orthogonal to the axis between the third pair of notches.
